(19) United States
(12) Patent Application Publication
(10) Pub. No.: US 2014/0018976 A1
(43) Pub. Date: Jan. 16, 2014

(54) SYSTEM AND METHOD FOR UNMANNED SYSTEM DATA COLLECTION, MANAGEMENT, AND REPORTING

(71) Applicant: HONEYWELL INTERNATIONAL INC., Morristown, NJ (US)

(72) Inventors: Emray Goossen, Albuquerque, NM (US); Derick Lucas Gerlock, Albuquerque, NM (US)

(73) Assignee: HONEYWELL INTERNATIONAL INC., Morristown, NJ (US)

(21) Appl. No.: 13/789,056

(22) Filed: Mar. 7, 2013

Related U.S. Application Data
(60) Provisional application No. 61/671,215, filed on Jul. 13, 2012.

(51) Int. Cl. G06F 17/00

(52) U.S. Cl. CPC G06F 17/00
USPC 701/2

(57) ABSTRACT

Data related to one or more unmanned aerial vehicles (UAVs) is collected and maintained by a device or system. The data may be organized and stored by any suitable memory structure, such as by a set of relational databases. In some examples, a system (or device) that stores such data is configured to generate a plurality of reports, such as a flight log for a particular UAV, a maintenance log for the UAV, and the like. The reports may, in some examples, need to be generated and submitted to governmental agencies in order to comply with governmental laws or regulations, such as U.S. Federal Air Regulations.

### CROSS-REFERENCE TO RELATED APPLICATION

This application claims the benefit of U.S. Provisional Application No. 61/671,215, filed Jul. 13, 2012.

### TECHNICAL FIELD

This disclosure relates to unmanned aerial vehicles, and more particularly to systems and methods for collecting, managing, and reporting UAV-related data.

### BACKGROUND

An unmanned aerial vehicle (UAV) is an aircraft that flies without a human crew on board the aircraft. A UAV can be used for various purposes, such as the collection of ambient gaseous particles, observation, thermal imaging, and the like. Operating and managing one UAV or a fleet of UAVs may involve the management of relatively large amount of data. This data management can be cumbersome and complex, particularly to operators with a lack of expertise in UAV operations and governmental laws and regulations. For example, to comply with certain laws and regulations, an operator may need to maintain one or more logbooks, including one or more Pilot-In-Control (PIC) logbooks and one or more UAV airframe (by tail number) logbooks. An aircraft manufacturer may also need to collect yearly tail number operations data for FAA reporting. These operations data may include, for example, aircraft operational hours, incidents, and maintenance data for a particular UAV, PIC qualifications and logbooks, and maintenance personnel qualifications and logbooks. Maintaining these logbooks and generating reports for the FAA or other regulatory agencies or entities will add to the cost of ownership to the relatively small UAV operators and to the manufacturer of certified systems.

Hence, there is a need for a system and method of automatically collecting, maintaining, and reporting relatively large amounts of data associated with unmanned system operations, and to do so with minimal effort to operator, manufacturer, and civil agencies. The present invention addresses at least this need.

### BRIEF SUMMARY

In one embodiment, an unmanned aerial vehicle (UAV) system, a UAV and a remote. The UAV is configured to at least selectively transmit data associated with the UAV. The remote control station is in operable communication with the UAV. The remote control station includes a memory and a processor. The processor is configured to receive the data selectively transmitted by the UAV and store the received data in the memory, selectively retrieve at least portions of the stored data, and selectively generate a plurality of reports associated with the UAV using at least the selectively retrieved data. The reports include an operator report, an operations report, and a maintenance report. The operator report includes information associated with an operator of the remote control station, the operations report, the operations report includes information associated with operations of the UAV, and the maintenance report includes information associated with maintenance of the UAV.

In another embodiment, a method for generating reports associated with an unmanned system that is controlled via a remote control station includes transmitting, to the remote control station, data related to the unmanned system. The transmitted data are stored in a memory. The remote control station selectively retrieves at least portions of the stored data, and generates a plurality of reports associated with the unmanned system using at least the selectively retrieved data. The reports include an operator report, an operations report, and a maintenance report. The operator report includes information associated with an operator of the remote control station, the operations report includes information associated with operations of the unmanned system, and the maintenance report includes information associated with maintenance of the unmanned system.

Furthermore, other desirable features and characteristics of the system and method will become apparent from the subsequent detailed description and the appended claims, taken in conjunction with the accompanying drawings and the preceding background.

### BRIEF DESCRIPTION OF DRAWINGS

The present invention will hereinafter be described in conjunction with the following drawing figures, wherein like numerals denote like elements, and wherein:

FIG. 1 is schematic diagram of a vehicle flight system including a UAV and a ground station;

FIG. 2 is a functional block diagram of an example ground station functional elements;

FIG. 3 illustrates an example top level user interface screen that may be presented by the ground station of FIG. 2;

FIG. 4 is a functional block diagram of an example database that is stored by the ground station of FIG. 2;

FIG. 5 is a conceptual diagram that illustrates an example flow of data between an Operator System and Asset Management user interface and a database stored by a ground station;

FIG. 6 illustrates an example Operator System and Asset Management user interface;

FIG. 7 illustrates an example user interface screen that may be presented by the ground station of FIG. 2, and includes information regarding a pilot-in-control (PIC) log book selection;

FIG. 8 is conceptual diagram that illustrates an example flow of data between PIC Log Book user interface screen of FIG. 7 and a database stored by a ground station;

FIG. 9 illustrates a user interface screen that presents options for viewing, printing, or saving reports generated by a ground station;

FIG. 10 is an example PIC Logbook report generated by a ground station.

FIG. 11 illustrates an example mission log management user interface screen presented by a ground station;

FIG. 12 illustrates an example user interface screen generated by a ground station, where the user interface screen include features that enable a user to view and manage maintenance information for one or more UAVs;

FIG. 13 is conceptual diagram that illustrates an example flow of data between the maintenance user interface screen of FIG. 12 and a database stored by a ground station; and

FIG. 14 is a block diagram that illustrates the interaction between an operators fleet and a manufacturer system.

### DETAILED DESCRIPTION

Devices, systems, and techniques for collecting and managing data related to one or more unmanned system, such as UAVs, are described herein. Data related to the UAV may include, for example, information regarding one or more pilots (e.g., one or more of certifications, training, and a flight history for each pilot of a group of pilots associated with an entity), UAV airframe information (e.g., tail numbers for one or more UAVs being managed by an entity), an inventory list of UAV parts (e.g., serial numbers identifying avionics for one or more UAVs owned or operated by a particular entity, sensor payloads available for use by an entity, and the like), operation data for a particular UAV (e.g., a total flight time for a UAV, a list of flight logs associated with a UAV, and the like), a list of incidents involving a particular UAV, maintenance data for a particular UAV (e.g., repair certifications and maintenance records), a list of available maintainers for a fleet of UAVs, and the like.

It will be appreciated that although described in the context of a UAV, the systems and methods described herein may be used in conjunction with other remotely operated devices. For example, it could additionally or instead be used in conjunction with small ground sensors and/or may disposable or expendable items (i.e. a leave behind sensor) in this same system for accounting purposes.

The devices, systems, and techniques described herein may assist in the maintenance of the logbooks, automated generation and transmission of reports, and other tasks that may be requested or required by the government or business, now or in the future. In some examples, the systems (or devices) described herein are configured to collect and organize data related to one or more UAVs (e.g., the UAVs owned, operated, or both, by a particular entity, such as a police department), and automatically generate the necessary reports (e.g., in response to user input) and maintain the logbooks that may be useful, or even necessary, for operating and managing one or more UAVs. The data may be organized and stored by any suitable memory structure of the system (or device), such as by a set of relational databases.

Maintaining UAV data using the devices, systems, and techniques described herein may also be useful for indicating, to the aircraft community (e.g., to current manned operators and organizations such as the Aircraft Owners and Pilots Association (AOPA), that small UAV manufacturers, operators, and pilots are able to provide small unmanned aircraft system maintenance and flight compliance to operate in the same airspaces as the manned aircraft. In addition, the devices, systems, and techniques described herein may also help reduce any perception in the emerging non-aircraft operator community that maintaining logbooks and generating reports that may be requested by a governmental agency or other entity is burdensome and reduces the value of owning and operating a UAV asset. Maintaining the operations, PIC, and maintenance data using these devices, systems, and techniques, can suffice for many of the civil authority maintenance and operator certification efforts.

While these examples focus on UAVs the systems and methods also apply to related devices such as ground robots, and other remotely managed or operated sensor systems and platforms. This is especially true for new emerging sensors that will be used in local and state law enforcement and commercial security services, as such, UAV is synonymous with remotely operated system and PIC is synonymous with remote system operator.

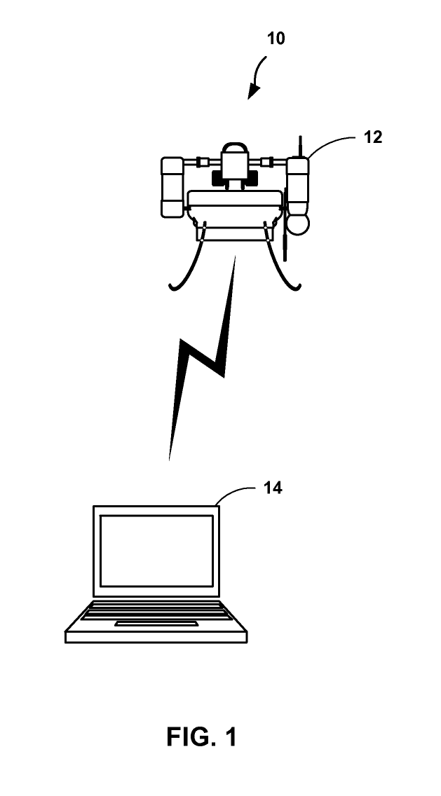

Referring now to FIG. 1, a schematic diagram of system 10 is depicted, and includes UAV 12 and ground station 14 (which may also be referred to as a “ground control station” in some examples). The UAV 12 and ground station 14 are preferably configured to wirelessly communicate although the connection could be tethered. The wireless communications to and from UAV 12 and ground station 14 may include any suitable wireless communication technologies, such as, but not limited to, any one or more of cellular, wireless network, or satellite technologies. For example, wireless communications in system 10 may be implemented according to one of the 802.11 specification sets, time division multi access (TDMA), frequency division multi access (FDMA), orthogonal frequency divisional multiplexing (OFDM), WI-FI, wireless communication over whitespace, ultra wide band communication, or any another standard or proprietary wireless network communication protocol. In another example, components of system 10 may employ wireless communications over a terrestrial cellular network, including, e.g. a GSM (Global System for Mobile Communications) network, a CDMA (Code Division Multiple Access) network, an EDGE (Enhanced Data for Global Evolution) network, a long term evolution (LTE) network, or any other network that uses wireless communications over a terrestrial cellular network. In other examples, any one or more of UAV 12 and ground station 14 may communicate with each other via a wired connection. This invention chooses the lowest-cost, most immediate communication channel(s) to send logging and reporting information to the other connected systems (remotely operated systems, ground stations, fleet management systems).

System 10 may be employed for various missions, such as to assist emergency personnel with a particular mission that involves the use of UAV 12, ground robot(s), emplaced/unattended sensors, disposable devices, supplies, or the like. In one example, a SWAT team may employ system 10 to fly UAV 12 in the course of executing a mission. For example, a SWAT team member trained in piloting UAV 12 may employ ground control station 14 to communicate with and operate (e.g., fly) UAV 12. The UAV 12 may be a short range hovering UAV or a long range fixed wing UAV, and an operator may have multiple systems 10 within his fleet.

In one example, UAV 12 is configured as a ducted fan UAV, which includes an engine, avionics and payload pods, and landing gear. The engine of UAV 12 may be operatively connected to and configured to drive the ducted fan of the vehicle. For example, UAV 12 may include a reciprocating engine, such as a two cylinder internal combustion engine that is connected to the ducted fan of the UAV by an energy transfer apparatus, such as, but not limited to, a differential. In another example, UAV 12 may include other types of engines including, e.g., a gas turbine engine or electric motor.

The ducted fan of UAV 12 may include a duct and a rotor fan. In some examples, the ducted fan of UAV 12 includes both a rotor fan and stator fan. In operation, the engine drives the rotor fan of the ducted fan of UAV 12 to rotate, which draws a working medium gas including, e.g., air, into the duct inlet. The working medium gas is drawn through the rotor fan, directed by the stator fan and accelerated out of the duct outlet. The acceleration of the working medium gas through the duct generates thrust to propel UAV 12. UAV 12 may also include control vanes arranged at the duct outlet, which may be manipulated to direct the UAV along a particular trajectory, i.e., a flight path or route plan. The duct and other structural components of UAV 12 may be formed of any suitable material including, e.g., various composites, aluminum or other metals, a semi rigid foam, various elastomers or polymers, aeroelastic materials, or even wood.

As noted above, UAV 12 may include avionics and payload pods for carrying flight control and management equipment, communications devices, e.g. radio and video antennas, and other payloads. In one example, UAV 12 may be configured to carry an avionics package including, e.g., avionics for communicating to and from the UAV and ground station 14. Avionics onboard UAV 12 may also include navigation and flight control electronics and sensors. The payload pods of UAV 12 may also include communication equipment, including, e.g., radio and video receiver and transceiver communications equipment and other sensor types. In one example, UAV 12 includes communications antennae, which may be configured for radio and video communications to and from the UAV and one or more microphones and cameras for capturing audio and video while in flight. While a ducted fan air vehicle is described with respect to FIG. 1, in other examples, other types of UAVs may be used with system 10. For example, instead of or in addition to a ducted fan air vehicle, system 10 may include a fixed wing UAV, a rotary wing UAV, or both.

Ground station 14 includes an operator control unit (OCU) that is configured to be employed by a pilot or remote operator to communicate with and control the flight of UAV 12. Ground station 14 may include a display device for displaying and charting flight locations of UAV 12, as well as video communications from the UAV in flight. Ground station 14 may also include a control device for a pilot to control the trajectory of UAV 12 in flight. For example, ground station 14 may include a control stick that may be manipulated in a variety of directions to cause UAV 12 to change its flight path in a variety of corresponding directions. In another example, ground station 14 may include input buttons, e.g. arrow buttons corresponding to a variety of directions, e.g. up, down, left, and right that may be employed by a pilot to cause UAV 12 to change its flight path in a variety of corresponding directions. In another example, ground station 14 may include another pilot control for directing UAV 12 in flight, including, e.g. a track ball, mouse, touchpad, touch screen, or freestick. Other input mechanisms for controlling the flight path of UAV 12 are contemplated to include waypoint and route navigation depending on the FAA regulations governing the specific mission and aircraft type.

In addition to the display and pilot control features, ground station 14 may include a computing device that includes one or more processors and digital memory for storing data and executing functions associated with the ground station. A telemetry module may allow data transfer to and from ground station 14 and UAV 12, e.g., according to a wired technique or one of the wireless communication techniques described above.

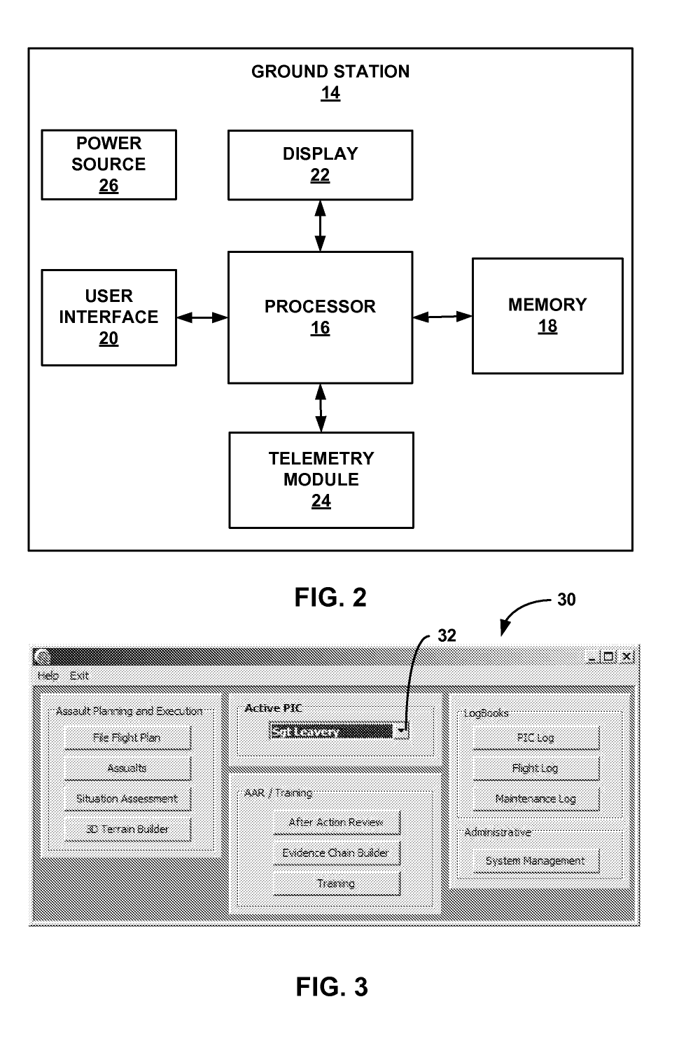

In one example, ground station 14 is configured to collect and manage data related to one or more UAVs 14. The data may include, for example, information regarding one or more pilots, information identifying UAV 12 (e.g., a tail number for UAV 12), and operation data for a particular UAV 12, such as the flight logs for UAV 12, a list of incidents involving UAV 12, a maintenance log for UAV 12, an expendables log for the purpose of tracking items delivered or emplaced by the UAV or ground robot (i.e. communications repeaters, tear gas dispensers, or the like.), and the like. The data related to one or more UAVs may also include, for example, a fleet configuration log for a fleet of UAVs. The configuration and function of ground station 14 will now be described. In doing so, reference should now be made to the example ground station 14 depicted in FIG. 2.

The example ground station 14, which is depicted in functional block diagram form in FIG. 2, includes processor 16, memory 18, user interface 20, display 22, telemetry module 24, and power source 26. In some examples, processor 16, memory 18, user interface 20, display 22, telemetry module 24, and power source 26 are enclosed in a common outer housing. The ground station 14 may vary in form to include a desktop, laptop, portable tablet, headless computer with head-mounted display, or even a smartphone.

Processor 16 is configured to control operation of memory 18, user interface 20, display 22, and telemetry module 24, all of which are powered by power source 26, which may be, for example, rechargeable in some examples. Power source 26 may include, for example, any one or more of a lithium polymer battery, a lithium ion battery, nickel cadmium battery, or a nickel metal hydride battery, or other emerging sources, fuel cell, harvesting techniques, solar, hybrid, etc. Ground station 14 can comprise any suitable arrangement of hardware, software, firmware, or any combination thereof, to perform the techniques attributed to ground station 14 and processor 16 herein. For example, processor 16 may include any one or more microprocessors, digital signal processors (DSPs), application specific integrated circuits (ASICs), field programmable gate arrays (FPGAs), or any other equivalent integrated or discrete logic circuitry, as well as any combinations of such components.

Memory 18 is configured to store data related to UAV 12, as well as any data necessary for the operation of ground station 14. For example, memory 18 may store instructions for applications and functions that may be executed by processor 16 and data used in such applications or collected and stored for use by ground station 14. For example, memory 18 may include a relational database structure that is configured to store and organize data related to UAV 12 and employed by processor 16 to automatically generate reports, such as flight logs, maintenance logs, and the like. Memory 18 may also store templates for one or more reports that comply with the governmental or other entity requirements. As such, the system 10 is also configured to quickly update and import new or changed templates. This also includes changing to new domains such as a ground robot or the like. Processor 16 may access the templates and data stored by memory 18 to automatically generate the reports.

In some examples, memory 18 includes any volatile or non-volatile media, such as a random access memory (RAM), read only memory (ROM), non-volatile RAM (NVRAM), electrically erasable programmable ROM (EEPROM), flash memory, and the like. Memory 18 may include instructions that cause processor 16 to perform various functions attributed to processor 16 in the disclosed examples. For example, memory 18 may store software that may be executed by processor 16 to perform various functions, including, e.g., report generation, data retrieval from remote databases, and generation and presentation of various user interface screens. The data that are logged form the foundation and basis for automated analysis for AAR functions.

User interface 20 may be implemented using any suitable mechanism configured to receive input from a user, such as a keypad, which may take the form of an alphanumeric keypad or a reduced set of keys, stylus, or voice commands, associated with particular functions. As discussed in further detail below, a user may interact with user interface 20 to input information related to UAV 12 or a fleet of UAVs including UAV 12, such as information regarding one or more pilots for the fleet, identifying information for each of the UAVs in the fleet, and the like. In addition, a user may interface with user interface 20 to retrieve information, e.g., about a particular UAV, a particular pilot, or to generate one or more reports (e.g., a maintenance log for a particular UAV) based on information stored by memory 18 or a memory of another device (e.g., a remote database in communication with ground station 14). In some examples, user interface 20 may include a microphone configured to receive voice commands from a user. Users may interact with user interface 20 and/or display 22 to execute one or more of the applications stored by memory 18. Some applications may be executed automatically by processor 16, such as when ground station 14 is turned on or booted up, while other applications may be executed in response to user input received via user interface 20 or display 22.

Display 22 may be implemented using any suitable type of display that is configured to present information to a user, including data relating to UAV 12, such as flight logs or maintenance logs for UAV 12. In some examples, display 22 may be implemented as a cathode ray tube (CRT) display, a liquid crystal display (LCD), an e-ink display, or a light emitting diode (LED) display, or head-mounted display, just to name a few. In addition or instead, in some examples, display 22 includes a touch screen display capable of displaying text and graphical images. For example, display 22 may be an LCD touch screen display capable of receiving input from a user (e.g., a pilot or operator) via, e.g., the user's fingers or a stylus.

As noted above, a pilot may employ ground station 14 to communicate with and control the trajectory of UAV 12 in flight, as well as to maintain and collect information about UAV 12, and, in some cases, a plurality of UAVs. In addition, a user may interact with ground station 14 to utilize the data maintenance and collection features. Processor 16 may be configured to autonomously generate (e.g., with little to no user intervention) and collect data regarding UAV 12 and, in some examples, one or more additional UAVs. This may help reduce the workload on the pilot and operator of UAV 12. Different example maintenance and collection features of ground station 14 are described below with reference to FIGS. 3-14. Individual ground stations may also be interfaced with a master ground station (or administrative computers and networks) for overall fleet management where independent systems are fielded.

Referring first to FIG. 3, an example user interface screen 30, which may be rendered by display 24 of ground station 14 or any other suitable computing device, is depicted. User interface screen 30 may be, for example, a menu screen that presents a high level overview of the different data management features of ground station 14 from which a user may select. As shown in FIG. 3, in one example, the features include various Mission Planning (such as Assault Planning) and Execution features, AAR/Training features, Administrative features, and LogBook generation.

As FIG. 3 also depicts, a user may interact with user interface 20, display 24, or both, to select a pilot (shown as “PIC” in FIG. 3) in order to log into the data management features of ground station 14. In the example shown in FIG. 3, processor 16 presents screen 30 with a pull down menu 32 from which the user may select a pilot from a list of available active pilots (e.g., properly certified pilots). The user may then be validated, e.g., via entry of a code (e.g., a password), fingerprint recognition, audio recognition, or any other suitable technique. The validation includes distinguishing authority to manage the system database, fly and enter flight log data, perform maintenance and maintain aircraft configurations, etc.

By selecting the buttons (e.g., via a button or peripheral pointing device of user interface 20) shown under the Assault Planning and Execution menu, the user may launch different programs (e.g., software programs) for performing the different tasks associated with the buttons. In the example shown in FIG. 3, the tasks include filing a flight plan, viewing different assaults, assessing situations in which UAV 12 may fly, and a 3D Terrain Builder for building a three-dimensional schematic of a terrain in which UAV 12 may fly. By selecting the buttons shown under the AAR/Training menu, the user may launch different programs (e.g., software programs) for performing the different tasks associated with the buttons, which may relate to training a pilot. The functionality associated with these features is not needed to understand or enable the present invention, and will therefore not be further described.

The Administrative features, which may be selected using the System Management button, a user may manage all the elements of his fleet; UAVs, Ground Stations, Maintenance Personnel qualifications, PIC qualifications, function add-ins such as the Assault Planning and Execution as well as AAR/Training software, expendables log, and repair components. By selecting the buttons shown under the LogBooks menu, the user may generate different reports, such as a PIC Log (which may include information relating to a particular pilot, such as a flight time of the pilot), a Flight Log (which may include information relating to a particular UAV flight, such as launch points, average flight speed, and the like), and a Maintenance Log for a particular UAV (which may include information regarding the maintenance performed or scheduled for the UAV). Each of the functions associated with selection of the System Management button and the buttons shown under the LogBooks menu will be described herein below. Before doing so, however, a description of the underlying database will be provided.

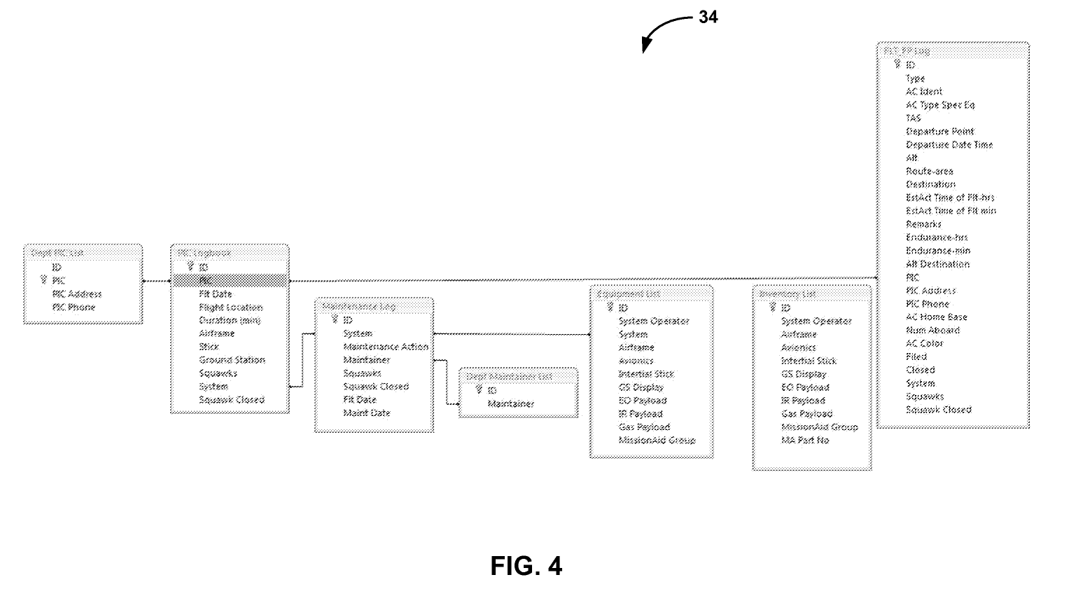

With reference now to FIG. 4, a functional block diagram of database 34, which may be stored by memory 18 of ground station 14, is depicted. Ground station 14 including database 34 provides a unique user interface and user tools for managing and viewing data related to UAV 12 and stored by database 34. Database 34 facilitates the data management features of ground station 14. Database 34 may have any suitable configuration. In the example shown in FIG. 4, database 34 is a relational database. Processor 16 may manage database 34 using any suitable technique. In some examples, processor 16 executes relational database management system software to store information in database 34 and retrieve information from database 34. For example, processor 16 may manage database 34 by implementing MySQL (structured query language) open source software, Firebird open source software, Microsoft Access software (available from Microsoft Corporation of Redmond, Wash.), or the like.

In the example shown in FIG. 4, database 34 comprises a plurality of formally described tables from which processor 16 (or another processor of another device) can access the data relatively easily. In one example, as shown in FIG. 4, database 34 includes seven tables: a pilot list (“Dept PIC List”) for a particular department (e.g., a SWAT team of a police department), a logbook (“PIC Logbook”) that stores information about each of the pilots, a Maintenance Log for each of the UAVs of a fleet of UAVs (including one or more UAVs) associated with the department, a list of approved maintenance personnel (“Dept Maintainer List”), a list of equipment associated with a particular UAV (“Equipment List”), which may include the list of payloads (e.g., sensor payloads) on the UAV, a list of available equipment and expendables (“Inventory List”), including the list of UAVs and payloads available for the UAVs (e.g., sensor and communications payloads), an Inventory List (“Inventory List”), and a flight plan log (“FLT FP Log”).

The seven tables interact with each other and processor 16 may access the data stored by the tables in order to automatically generate various reports (e.g., a report of all available pilots and the certification information for each available pilot) and logs (e.g., flight logs and maintenance logs). In addition, as processor 16 receives data from a user, e.g., via user interface 20, processor 16 may store the data in the appropriate table of database 34.

The fields shown in FIG. 4 and described in each of the seven tables depicted therein represent the basic information stored and used by processor 16 to accomplish the functions described herein, such as the generation of various reports. However, in other examples, other fields can add valued information to ground system 14. In addition, in other examples, database 34 can have any suitable configuration. For example, database 34 may be a relational database with more than seven tables, less than seven tables, or another type of database that does not include tables and can support related (but not specifically described) robotics and sensor missions for ground robots, sensors, UAVs, and other remotely operated sensors that may be specifically a part of the example UAV mission or operated independently or operated under any other combination of remotely operated devices.

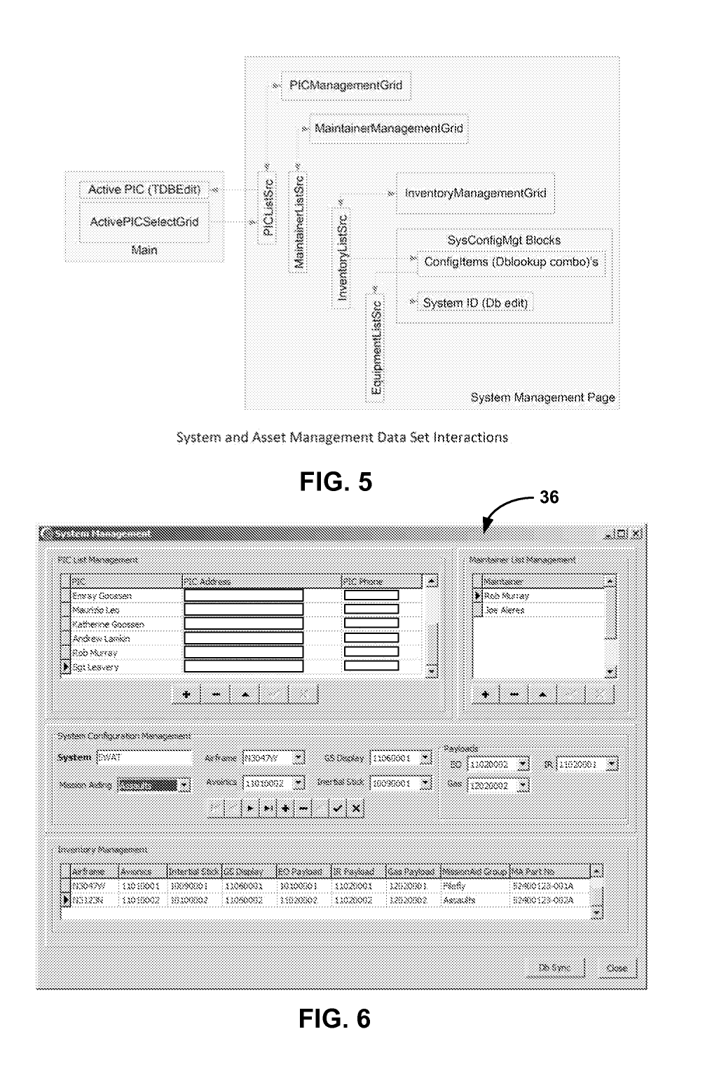

Referring back to FIG. 3, when the System Management button is selected, the processor 16 of ground station 14 implements an Operator System and Asset Management function. The Operator System and Asset Management function establishes the foundational information upon which the data management features of ground station 14 operates. For example, a user may interact with user interface 36 to input information into database 34 relating to the PIC List Source (available PICs for a particular entity), Maintainer List Source (e.g., available maintainers for the entity), Inventory List Source, and Equipment List Source datasets for the entity. An example Operator System and Asset Management user interface 36, generated and presented by processor 16 in response to selection of the System Management button, is depicted in FIG. 6. A conceptual diagram that illustrates an example flow of data between Operator System and Asset Management user interface 36 and database 34, and related to the Operator System and Asset Management features provided by processor 16 of ground system 14 is depicted in FIG. 5.

The example user interface 36 includes a plurality of graphical buttons and pull down menus that enable a user to navigate through each of the data sets. The user may interact with user interface 36 to manage a plurality of UAVs. For example, a user (e.g., an operator manager for a fleet of UAVs) may interact with user interface 36 to input information to processor 16, which may store the information in database 34. The user may, for example, input information to establish a particular group of UAVs (labeled in FIG. 6 as a “System” and referred to herein as a “UAV System”), the UAVs assigned to the UAV System, and the individual configuration items for each of the UAVs of the UAV System. The user may be charged with managing a plurality of groups of UAVs (i.e., a plurality of “UAVSystems”). For example, a police department may be organized such that an operator manages the UAVs for both a SWAT team and a police patrol team, where the SWAT team and police patrol team have different UAVs. The user may also interact with user interface 36 to assign a UAV to a particular mission team (labeled in FIG. 6 as a “System”) that will be flying the UAV, to assign a particular maintainer to a UAV system, and the like. In some examples, processor 16 limits access to Operator System and Asset Management user interface 36 to authorized users, e.g., by protecting access to Operator System and Asset Management user interface 36 via a password.

As shown in FIGS. 5 and 6, in response to receiving user input selecting PICs, processor 16 may access database 34, and retrieve information regarding the PICs, such as the addresses and phone numbers of the PICS. Processor 16 may also update database 34 such that the selected PICs are stored, which may then affect a list of available PICs (e.g., a PICManagement Grid, as shown in FIG. 6). In addition, processor 16 may update the list of PICs presented by user interface 36.

Similarly, in response to receiving user input selecting one or more maintainers for the particular UAV system, processor 16 may access database 34, and retrieve information regarding the maintainers. Processor 16 may also update database 34 such that the selected maintainers are stored, which may then affect a list of available maintainers (e.g., a MaintainerManagementGrid, as shown in FIG. 5). In addition, processor 16 may update the list of maintainers presented by user interface 36

In response to receiving user input selecting one or more UAVs for the particular UAV system and the configuration for the UAVs, processor 16 may update the Inventory Management list of user interface 36. In addition, processor 16 may access database 34 stored by memory 18 and retrieve information regarding the UAVs, such as information regarding the configuration of the UAVs (e.g., the avionics serial numbers, information identifying the payload pods of the UAV, etc.). In the example shown in FIG. 5, user interface 36 includes a database synchronization function, which enables processor 16 to access information from other databases in order to retrieve information for database 34. In particular, in the example shown in FIG. 5, user interface 36 includes a “Db Synch” button. In response to receiving user input selecting the “Db Synch” button, processor 16 may query a local or remote database (e.g., a database of a UAV manufacturer) to load information from the database. For example, processor 16 may query a remote manufacturer database in order to load serial numbers for UAV parts (e.g., avionics, sensor payloads, communications payloads, expendables, and the like) into database 34, as well as to load data relating to the configurations of UAVs that were purchased by the entity. In this way, the “Db Synch” button may help a user obtain information relating to one or more UAVs in a relatively quick manner, because processor 16 may automatically retrieve some data from another source, rather than requiring the user to manually input the data. In some examples, the database synchronization feature may also enable processor 16 to synchronize system flight logs and squawks (e.g., reported issues for a particular UAV) with the manufacturer, which may be useful for Federal Aviation Administration reporting purposes and provides the ability to import new or updated templates.

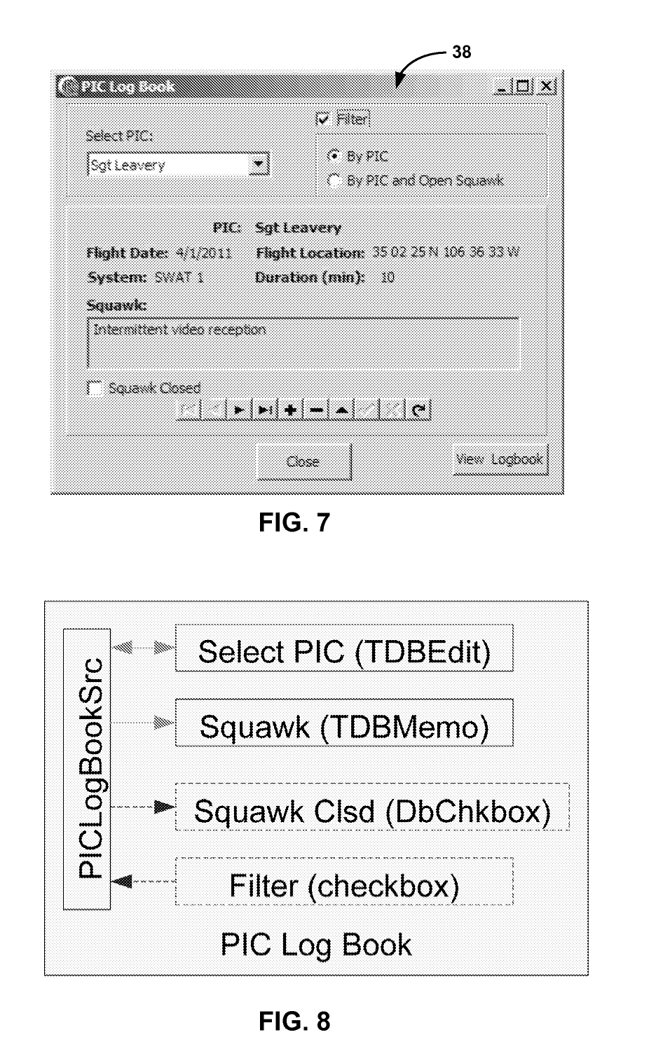

Turning now to FIG. 7, an example user interface screen 38 is depicted. This interface screen 38, which is referred to herein as a PIC Log Book interface screen, may be rendered by display 22 in response to a user selecting the PIC Log button of user interface screen 30 (see FIG. 3). In the depicted embodiment, PIC Log Book interface screen 38 is rendered as a menu screen that allows a user to select a particular PIC (via a Select PIC drop-down) and view information regarding the particular PIC that is selected. For example, the user may view the selected PIC's last flight date, the assigned UAV System, flight time, Squawks (e.g., issues) reported by the selected PIC, and the like. The user may filter the PIC Log Book data by a PIC, by a PIC and Open Squawk, or any one of numerous other criteria.

In some examples, PIC Log Book user interface screen 38 provides a PIC with an interface to view his (or her) personal logbook. This allows a PIC to view their individual flights, add squawk entries, and view/print their associated flight log record. Processor 16 populates information presented in PIC Log Book user interface screen 38 from database 34 and from the flight in progress, with the exception of the squawk field, which may be filled in by the PIC. In some cases, only a maintainer is authorized to close the Squawk, and when the Squawk is closed, the Squawk Closed box will be checked.

FIG. 8 is a conceptual diagram that illustrates an example flow of data between PIC Log Book user interface 38 (FIG. 7) and database 34. As shown in FIG. 8, processor 16 may interact with database 34 to retrieve data regarding a PIC selected by a user via user interface 38. The processor 16 may also retrieve data regarding Squawks associated with the selected PIC, and data regarding whether a Squawk has been closed (e.g., investigated and closed by a maintainer). The data flow shown in FIG. 8 may be related to the PIC management features provided by processor 16 of ground system 14.

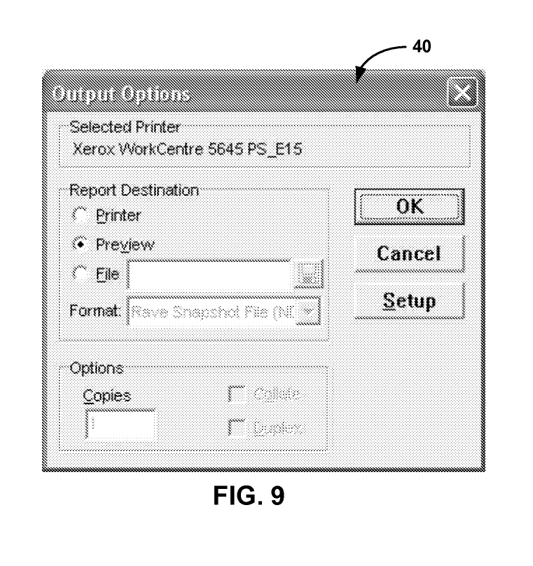

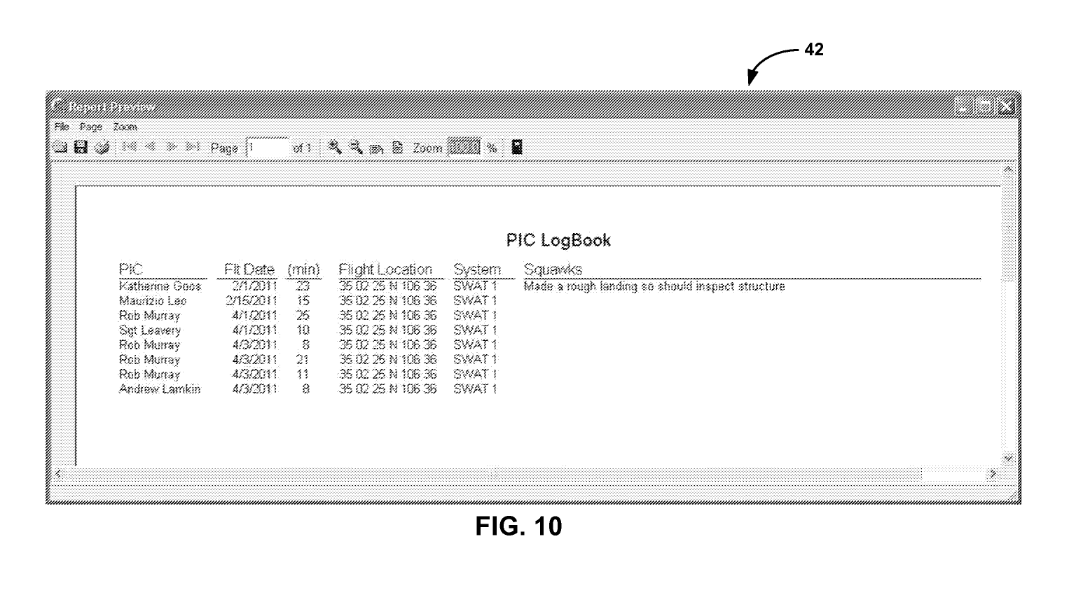

PIC Log Book user interface screen 38 additionally includes a View Logbook selection button. When a user selects this button, an Output Options user interface screen 40 is rendered on display 22. The Output Options user interface 40, which is depicted in FIG. 9, allows a user to view, print, or save a report to a file. For example, after a user interacts with PIC Log Book user interface 38 (FIG. 7), the user may provide input via Output Options user interface 40 to view the PIC Log Book. In response to a user selecting the Preview option on the Output Options user interface screen 40, processor 16 may generate a PIC LogBook and present the PIC Logbook, via example user interface screen 42 depicted in FIG. 10. The report generated by processor 16 and shown in FIG. 10 may enable the user to relatively quickly view and compare available PICs.

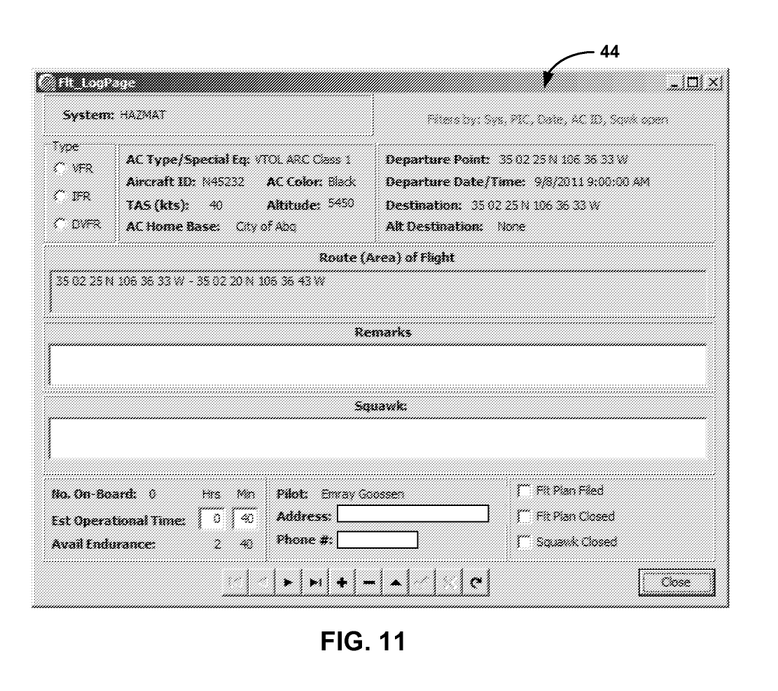

FIG. 11 illustrates another example user interface screen 44 that may be rendered on display 22. This interface screen 44, which is referred to herein as a Flight Log Management user interface screen, may be rendered by display 22 in response to a user selecting the Flight Log button of user interface screen 30 (see FIG. 3). Flight Log Management user interface screen 44 may include features that enable a user to view flight information and generate a flight log. With a properly populated database, the system 10 automatically fills in all the fields where data is contained in the database (all greyed out fields); AC type/Special Eq, Aircraft ID, TAS (kts), AC Home Base, etc. In some examples, processor 16 may receive input from a user via Flight Log Management user interface screen 44 that indicates whether a flight log should be generated for a particular UAV System, PIC, date, a particular UAV (e.g., identified by the avionics identification number), or for only those UAVs that have an open Squawk (e.g., a potential technical issue not yet addressed by maintainer). In response to receiving the input, processor 16 may filter the flight information and generate the requested flight log based on the filtered information stored by database 34. For completeness, it is noted that in FIG. 11, “VFR” is an acronym for “visual flight rules,” “IFR” is an acronym for “instrument flight rules,” and “DFR” is an acronym for “Degraded Visual Flight Rules.”

As FIG. 11 also depicts, Flight Log Management user interface screen 44 may additionally include information that identifies a UAV, the departure point, date, and time for a particular flight, the destination for the flight, the route taken by the UAV, the estimated operational time, the PIC and respective information (e.g., address and phone number), whether a flight plan was filed for the flight, whether there are any open Squawks from the flight, and the like. Flight Log Management user interface screen 44 also provides a view into the flight log data set, and allows a user to provide entries into certain fields. In some examples, the greyed out items shown in FIG. 11 are automatically populated by processor 16, e.g., based on data from database 34.

In some embodiments, processor 16 may receive flight data from one or more sensors aboard a UAV. Such flight data may include, for example, the departure point (e.g., received from a GPS device aboard the UAV), the operational time, the flight time, and the like. Processor 16 may receive the flight data directly from the sensors or a user may input the information into ground station 14. Moreover, in some embodiments, processor 16 is configured to determine the route, departure, and destination points from a graphical mapping function provided by processor 16, in which a user (e.g., a PIC) may define a flight path on a map presented by processor 16. The mission aiding function provided by processor 16 may convert the flight path to latitude and longitude, and processor 16 may log this information into database 34. Any deviations that may occur during the planned flight will alter the actual route information stored by processor 16 in database 34. Data representative of sensed location, time of flight, duration of flight, etc. are added to the database automatically without user intervention.

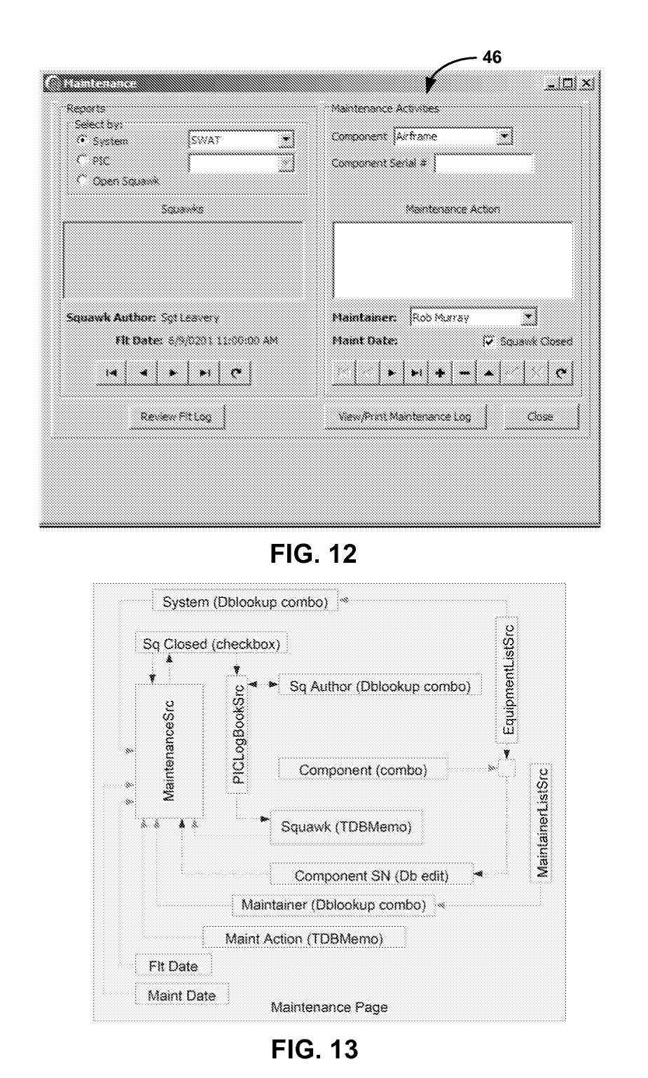

Turning now to FIG. 12, another example user interface screen 46 that may be rendered by display 22 is depicted. This user interface screen 46, which is referred to herein as the Maintenance Log Management user interface screen 46, may be rendered by display 22 in response to a user selecting the Maintenance Log button of user interface screen 30 (see FIG. 3). The Maintenance Log Management user interface screen 46 enables a user to view and manage maintenance information for a particular UAV System, PIC, or view open Squawks (e.g., for a fleet of UAVs managed by the user or associated with a common entity, or both). In some embodiments, access to Maintenance Log Management user interface screen 46 is limited to authorized users. In such embodiments, processor 16 first validates a user via password, fingerprint identification, or using any other suitable technique, before allowing access to Maintenance Log Management user interface screen 46.

Maintenance Log Management user interface screen 46 provides a view into the maintenance log dataset of database 34, and may, for example, provide a user (e.g., an authorized maintainer) with Squawk information correlated with the UAV System against which the Squawk action was written by a PIC. After a user (e.g., a maintainer) determines the associated with a Squawk, and repairs or replaces a one or more components, the user logs that action into the Maintenance Action section, and closes the Squawk out. In response to receiving the user input closing the Squawk, processor 16 may update database 34. In some examples, the user may view/print the maintenance log, which processor 16 may filter by any suitable criterion, such as by UAV system, component (e.g., configuration item), serial number, or PIC. The user may interact with user interface screen 46 to generate reports in order to satisfy, e.g., FSDO maintenance and repair reporting requirements. In addition, the system will automatically populate a warranty request (if qualified) and parts purchase orders, as required.

A user may interact with Maintenance Log Management user interface screen 46 to view maintenance activities organized by a plurality of different categories, such as maintenance activities for a particular component (e.g., identified by part (e.g., airframe) or component serial number), as well as to view the maintainer and the maintenance dates. Many of these fields, such as Squawk, Squawk Author, and flight date, are auto-populated for maintainer workload reduction, and could include flight condition information to assist the maintainer in solving the Squawk In response to receiving user input via user interface screen 46 selecting a particular category, processor 16 may retrieve the corresponding maintenance data for the selected category from database 34 and present the data to the user via user interface screen 46 or another user interface screen. Maintenance Log Management user interface screen 46 also enables a user to query and search database 34 for desired information relating to maintenance of a UAV or a plurality of UAVs. Thus, the maintenance data management features of ground station 14 may help the user manage a fleet of UAVs and reduce the burden of organizing maintenance data.

A conceptual diagram that illustrates the flow of data between Maintenance Log Management user interface screen 46 and database 34, under the control of processor 16, is depicted in FIG. 13. As shown in FIG. 13, processor 16 may interact with database 34 to retrieve maintenance data from a plurality of different tables. The data flow shown in FIG. 13 may be related to the maintenance log features provided by processor 16 of ground system 14.

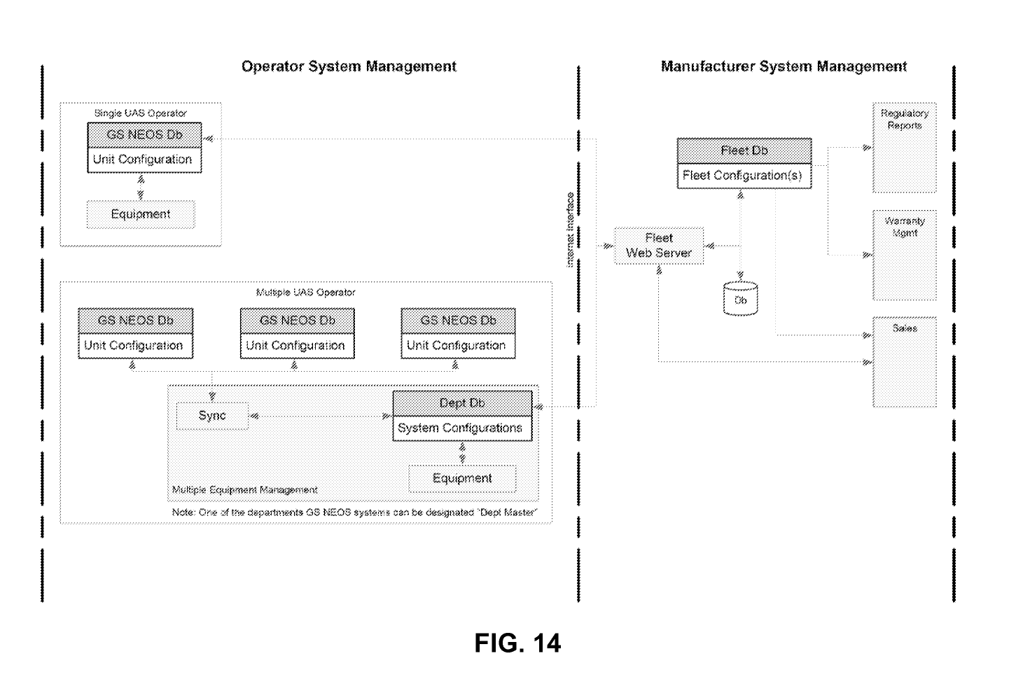

As discussed with respect to FIG. 6, in some examples, processor 16 may query another database to retrieve data stored in database 34. Such data may include data relating to the configuration of a UAV purchased from a manufacturer. FIG. 14 is a block diagram that illustrates the interaction between ground system 14 and a Manufacturer System Management system. The diagram shown in FIG. 14 illustrates the mechanisms that support data synchronization between operators of UAVs and a UAV manufacturer via, for example, the internet. For some operators, the connection may be an internet interface to the manufacturer's website. For other operators (e.g., operators managing multiple UAV systems), the system may be configured such that there is an operator department level system configuration collection that synchronizes the individual datasets for each UAV system, giving the operator a unified picture of the managed fleet. However the operator can individually connect each UAV system to the fleet website as well and obtain retrieve a fleet summary from there.

As shown in FIG. 14, an Operator System Management, e.g., provided by ground system 14, may access a fleet web server (e.g., hosted by the manufacturer of the UAVs in a fleet) in order to obtain information from the Manufacturer System Management regarding the configuration of the UAVs in the fleet. The manufacturer may be a source of the information regarding the configuration of a particular UAV (e.g., the tail number, color, avionics serial numbers, and the like). In some embodiments, processor 16 may also retrieve other information from the manufacturer, such as warranty information, regulatory reports, field quality evaluations (e.g., maintenance and reliability data collection for a particular UAV or a particular type of UAV), marketing assessment of system and payload utility, and environmental impact (carbon footprint, etc.) information, and mission execution data, and store this information in memory 18. In this way, processor 16 may help consolidate data useful for managing a fleet of UAVs in one central location. In some embodiments, the manufacturer system may be configured to automatically send out notices and pre-planned maintenance alerts to operators via the web server.

The collection of capabilities described herein address a plurality of FAA FSDO reporting requirements necessary to maintain PIC currency, operator operations and maintenance compliance FSDO reporting, and manufacturer production and field quality control and FSDO reporting. For example, the PIC logbooks generated by processor 16 may satisfy a requirement to document flight crew qualifications from flight crew training in compliance with various certification authorities. As another example, the maintenance logbooks generated by processor 16 satisfy maintenance and alteration requirement in compliance with FAR 107 and ASTM-F38 and a requirement related to allowable vehicle configurations in compliance with ASTM-F38. For systems not regulated by governmental authorities, there may be alternate regulations that this invention will provide qualification data to support on-going operations.

Functions executed by electronics associated with ground station 14 may be implemented, at least in part, by hardware, software, firmware or any combination thereof. For example, various aspects of the techniques may be implemented within one or more processors, including one or more microprocessors, DSPs, ASICs, FPGAs, or any other equivalent integrated or discrete logic circuitry, as well as any combinations of such components, embodied in electronics included in OCU 22. The term “processor” may generally refer to any of the foregoing logic circuitry, alone or in combination with other logic circuitry, or any other equivalent circuitry.

This invention automates and unifies operational, manufacturing, and regulatory information necessary for safe operation, certification, repair and warranty. In addition, this invention enables resource and skill limited operators (and organization) to achieve compliance with regulatory, polices, and guidelines in a cost effective manner.

The systems and methods described herein include numerous automated reports and logging functions such as: the 1) Flight Log; 2) the PIC Report; 3) the Maintenance Log; 4) the Expendables Log for tracking supplies or items that may be dropped or emplaced by the remote system; 5) the Mission Execution Log that automatically includes the where, the when, a devices used list, and a list of system functions used by the PIC or operators. To complete the Mission Execution Log, the Operator will input or list the mission objectives; 6) the System Value Log that measures items such as cost per flight hour and automatically pings external sources for current market prices for fuel, oil, and electricity and then compares that to current flight hours for unit helicopters and other comparable assets; 7) the Mission Time-Line Log provides data elements for the adjacent After Action Review (AAR) system and other analysis tools. For example, the invention will automatically log time, location, and events on a graphical timeline. This will include mission information such as: the mission start time and location, all system alerts (i.e. bingo fuel, fault indicators and the like), any operator inputs (i.e. if the PIC taps the video display to place a tracking box around a suspect, places an item-of-interest on the map, sends camera commands, makes route changes, switches between manual and pre-planned operations and the like), periodic location tags for the system entities (i.e. the UAV or remote system, the operator, any known friendly units and the like), any automated behavior events (i.e. video analytics where the system counts the number of cars or people in a given scene), and the mission end time and location.

The techniques of this disclosure may be implemented in a wide variety of computer devices. Any components, modules or units have been described provided to emphasize functional aspects and does not necessarily require realization by different hardware units. The techniques described herein may also be implemented in hardware, software, firmware, or any combination thereof. Any features described as modules, units or components may be implemented together in an integrated logic device or separately as discrete but interoperable logic devices. In some cases, various features may be implemented as an integrated circuit device, such as an integrated circuit chip or chipset.

If implemented in software, the techniques described herein and functions ascribed to ground station 14 (e.g., processor 16) may be realized at least in part by a computer-readable medium comprising instructions that, when executed in a processor, performs one or more of the methods described above. The computer-readable medium may comprise a tangible computer-readable storage medium and may form part of a larger product. The computer-readable storage medium may comprise random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The computer-readable storage medium may also comprise a non-volatile storage device, such as a hard-disk, magnetic tape, a compact disk (CD), digital versatile disk (DVD), Blu-ray disk, holographic data storage media, or other non-volatile storage device.

The term “processor,” as used herein may refer to any of the foregoing structure or any other structure suitable for implementation of the techniques described herein. In addition, in some aspects, the functionality described herein may be provided within dedicated software modules or hardware modules configured for performing the techniques of this disclosure. Even if implemented in software, the techniques may use hardware such as a processor to execute the software, and a memory to store the software. In any such cases, the computers described herein may define a specific machine that is capable of executing the specific functions described herein. Also, the techniques could be fully implemented in one or more circuits or logic elements, which could also be considered a processor.

In this document, relational terms such as first and second, and the like may be used solely to distinguish one entity or action from another entity or action without necessarily requiring or implying any actual such relationship or order between such entities or actions. Numerical ordinals such as “first,” “second,” “third,” etc. simply denote different singles of a plurality and do not imply any order or sequence unless specifically defined by the claim language. The sequence of the text in any of the claims does not imply that process steps must be performed in a temporal or logical order according to such sequence unless it is specifically defined by the language of the claim. The process steps may be interchanged in any order without departing from the scope of the invention as long as such an interchange does not contradict the claim language and is not logically nonsensical.

Furthermore, depending on the context, words such as “connect” or “coupled to” used in describing a relationship between different elements do not imply that a direct physical connection must be made between these elements. For example, two elements may be connected to each other physically, electronically, logically, or in any other manner, through one or more additional elements.

While at least one exemplary embodiment has been presented in the foregoing detailed description of the invention, it should be appreciated that a vast number of variations exist. As mentioned above, the embodiment of this invention applies to other types of robots and remotely operated systems. That can operate individually or combined with one another to support various mission needs and the related administrative tasks required to support those missions. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention. It being understood that various changes may be made in the function and arrangement of elements described in an exemplary embodiment without departing from the scope of the invention as set forth in the appended claims.

What is claimed is:

1. An unmanned aerial vehicle (UAV) system, comprising:
a UAV configured to at least selectively transmit data associated with the UAV;
a remote control station in operable communication with the UAV, the remote control station including a memory and a processor, the processor configured to:
receive the data selectively transmitted by the UAV and store the received data in the memory,
selectively retrieve at least portions of the stored data; and
selectively generate a plurality of reports associated with the UAV using at least the selectively retrieved data, the reports including:
(i) an operator report, the operator report including information associated with an operator of the remote control station,
(ii) an operations report, the operations report including information associated with operations of the UAV; and
(iii) a maintenance report, the maintenance report including information associated with maintenance of the UAV.

2. The system of claim 1, wherein:
the memory further has system data associated with the UAV stored therein; and
the processor is further configured to (i) selectively retrieve at least a portion of the system data and (ii) generate the plurality of reports using at least a portion of the selectively retrieved system data.

3. The system of claim 1, wherein the data are stored in the memory in a relational database.

4. The system of claim 1, further comprising:
one or more additional UAVs in operable communication with the remote control station.

5. The system of claim 1, wherein the memory has stored therein templates for one or more of the operator report, operations report, and maintenance report in the memory, the stored templates complying with regulatory agency requirements.

6. The system of claim 5, wherein the processor is further configured to automatically populate one or more fields in one or more of the stored templates with portions of the stored data.

7. The system of claim 5, wherein the processor is further configured to automatically and periodically update the stored templates.

8. The system of claim 1, further comprising:
a display in operable communication with the processor and configured to selectively render one or more images; and
a user interface in operable communication with the processor and configured to receive input from a user.

9. The system of claim 8, wherein the processor is further configured to:
command the display to render a user validation screen; and
validate a user of the remote control station based on data entered into the user validation screen.

10. The system of claim 8, wherein the processor is further configured to:
command the display to render a system management user interface, the system management user interface including a plurality of system-related data fields; and
selectively modify data rendered in one or more of the system-related data fields in response to input from the user interface,
wherein the system related data fields include data fields related to UAV users, UAV maintainers, UAV configuration, and UAV inventory.

11. The system of claim 8, wherein the processor is further configured to:
command the display to render an operator logbook user interface, the operator logbook user interface configured to allow a user to select particular operators; and
upon selection of an operator, command the display to generate information related to the selected operator.

12. The system of claim 11, wherein:
the operator logbook user interface is further configured to allow a user to request an operator report associated with a selected operator; and
the processor is further configured to command the display to render the operator report associated with the selected operator.

13. The system of claim 8, wherein the processor is further configured to:
command the display to render flight log management user interface, the flight log management user interface configured to allow a user to view flight information associated with the UAV and at least selectively generate the operations report.

14. The system of claim 8, wherein the processor is further configured to:
command the display to render maintenance user interface, the maintenance user interface configured to allow a user to view and manage maintenance-related data associated with the UAV and at least selectively generate the maintenance report.

15. The system of claim 1, wherein the remote control station is further configured to:
at least selectively communicate with a remote manufacturer database; and
retrieve at least selected portions of data stored in the remote manufacturer database.

16. A method for generating reports associated with an unmanned system that is controlled via a remote control station, the method comprising the steps of:
transmitting, to the remote control station, data related to the unmanned system;
storing the transmitted data in a memory;
selectively retrieving, in the remote control station, at least portions of the stored data; and
generating, in the remote control station, a plurality of reports associated with the unmanned system using at least the selectively retrieved data, the reports including:
(i) an operator report, the operator report including information associated with an operator of the remote control station,
(ii) an operations report, the operations report including information associated with operations of the unmanned system; and
(iii) a maintenance report, the maintenance report including information associated with maintenance of the unmanned system.

17. The method of claim 16, further comprising:
storing system data associated with the unmanned system in the memory;
selectively retrieving at least a portion of the system data; and
generating the plurality of reports using at least a portion of the selectively retrieved system data.

18. The method of claim 16, wherein the data are stored in the memory in a relational database.

19. The method of claim 16, wherein the unmanned system comprises an unmanned aerial vehicle.

20. The method of claim 16, further comprising:
storing templates for one or more of the operator report, operations report, and maintenance report in the memory, the stored templates complying with regulatory agency requirements;
automatically populating one or more fields in one or more of the stored templates with portions of the stored data; and
automatically and periodically updating the stored templates.
